(19) United States
(12) Patent Application Publication
(10) Pub. No.: US 2009/0002936 A1
(43) Pub. Date: Jan. 1, 2009

(54) Computer peripheral for removable cartridge media

(76) Inventor: Marc Jacques Lalouette, Boulder, CO (US)

Correspondence Address: Marc Lalouette, 3344 16th Street, Boulder, CO, 80304, US

(21) Appl. No.: 11/821,815

(22) Filed: Jun. 26, 2007

(51) Int. Cl. G06F 1/16

(52) U.S. Cl. 361/685

(57) ABSTRACT

A desktop external drive that is configured to accept a removable disc drive cartridge with the direction of insertion in the vertical orientation such that the narrow edge of both the disc drive cartridge and desktop external drive are oriented towards the user.

### FIELD OF THE INVENTION

This invention relates to the field of generally removable disc drives, also referred to as disc drive cartridges, and a desktop external drive that receives the cartridges in a vertical orientation with the narrow dimension facing the user such that the desktop external drive takes up minimal useable desk space.

### BACKGROUND OF THE INVENTION

A removable disc drive cartridge is a type of removable media that is employed to store and to physically transport data between two different locations. Typically, a disc drive cartridge transports data between two different computers that are each located at different locations, or is used for offsite backup for disaster recovery purposes. Other types of removable media, such as compact discs (CD), digital video discs (DVD), tape cartridges or flash memory keys can also be used to physically transport data between two different computers.

Patents and patent publications that relate to the general subject matter of removable disc drive cartridges include U.S. Pat. No. 4,941,841 to Darden, U.S. Pat. No. 5,837,934 to Valavanis, U.S. Pat. No. 6,154,360 to Kaczeus, and U.S. 2005/0257949 to Lalouette.

These cartridges are inserted into drives that either reside inside a personal computer chassis, a server rack, or as desktop external drives that connect to a host computer through an interface cable (typically USB or 1394) or wirelessly. This invention pertains to desktop external drives that accept hard drive cartridges. Differences between existing desktop external drives that accept hard drive cartridges and the subject of this invention are detailed herein.

### SUMMARY OF THE INVENTION

The invention provides an improved user experience by orienting the desktop external drive to accept the cartridge vertically, with the narrow dimension facing the user. Desktop Desktop external disk drives have become a popular means of backing up the data on a host computer, and most of these designs employ a vertical end on orientation to minimize desk space footprint. This orientation is defined by having the user interface features, typically lights indicating operation, on off buttons, buttons to launch backup applications or the like located either on the surface facing the intended user, or in the case of features that are best hidden from the field of view of the user, such as cables, on the rear of the unit facing directly away from the intended user. Removable media drives (tape cartridges, hard drive cartridges, USB keys) have previously loaded the cartridge media in the horizontal plane. This presents a difficulty to the user in desktop external drive applications, where the engagement force generated by mating the media into an electrical connector on the receiving external drive acts to push the external drive across the desk, requiring the user to stabilize the unit with one hand while inserting the removable media with the other. Some existing designs overcome this difficulty by placing a motorized loading and unloading mechanism that draws the cartridge in when presented, and ejects it when the user requests, but this increases the cost and complexity of the desktop external drive. In this invention by orienting the cartridge insertion in the vertical direction the insertion forces are caused to be supported by desk, stabilizing the drive. Similarly, upon removal, the weight of the desktop external drive unit acts to stabilize it, keeping it from being lifted from the desk by the media exaction force required to dislodge the cartridge from the electrical connector it makes contact with. By designing the desktop external drive to accept the cartridge in such a way that the smallest surface of the drive is oriented facing the user (end on), useable desk space is optimized

### BRIEF DESCRIPTION OF THE DRAWINGS

The objects and features of the invention can be better understood with reference to the claims and drawings described below. The drawings are not necessarily drawn to scale, and the emphasis is instead generally being placed upon illustrating the principles of the invention. Within the drawings, like reference numbers are used to indicate like parts throughout the various views. Differences between like parts may cause those parts to be indicated by different reference numbers. Unlike parts are indicated by different reference numbers.

For a further understanding of these and objects of the invention, reference will be made to the following detailed description of the invention which is to be read in connection with the accompanying drawing, wherein:

FIG. 1 illustrates an exploded view of a removable disc drive cartridge.

FIG. 2A illustrates a view of the desktop external drive with the cartridge about to be inserted in accordance with the invention.

FIG. 2B illustrates a view of the desktop external drive with the cartridge inserted in the desktop external drive in accordance with the invention.

FIG. 3 illustrates a magnified view of the electrical connector of the hard drive inside the cartridge (which is not shown) about to engage with the mating connector interior to the desktop external drive (also not shown in this view)

### DETAILED DESCRIPTION OF THE INVENTION

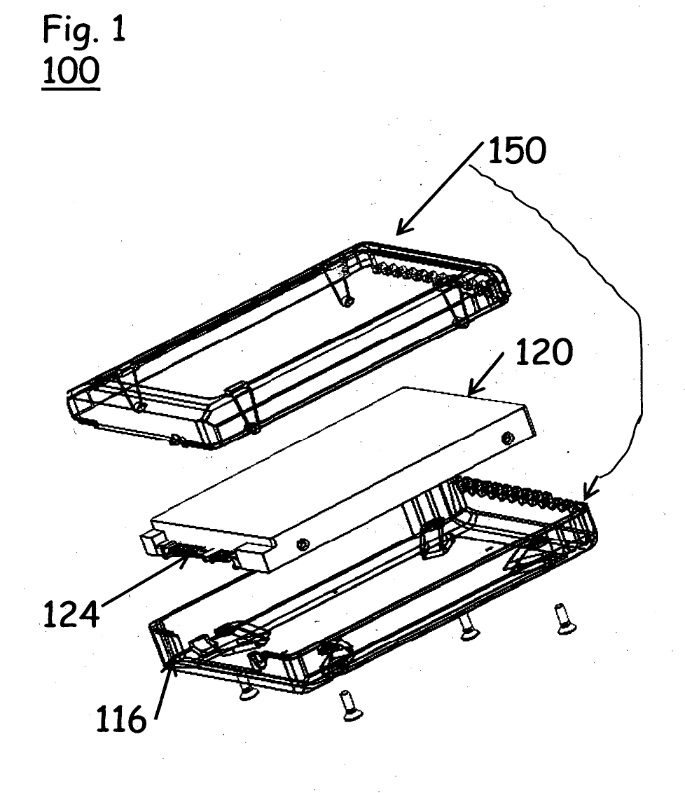

FIG. 1 illustrates an exploded view of a removable disc drive cartridge 100. As shown, the removable disc drive cartridge 100, also referred to as a cartridge 100, is comprised of an enclosure 150. The enclosure 150 is configured to surround and to protect a disc drive 120, and has an opening to provide access to a plurality of electrical connections 124 of a disc drive 120. T]e electronic connectors 124 are configured to electronically connect to a complementary set of electronic connectors 125 provided within a desktop external drive 160.

The enclosure 150 is configured to provide an opening 116 within its front side to allow passage of electronic connectors protruding from a front side of the disc drive 120.

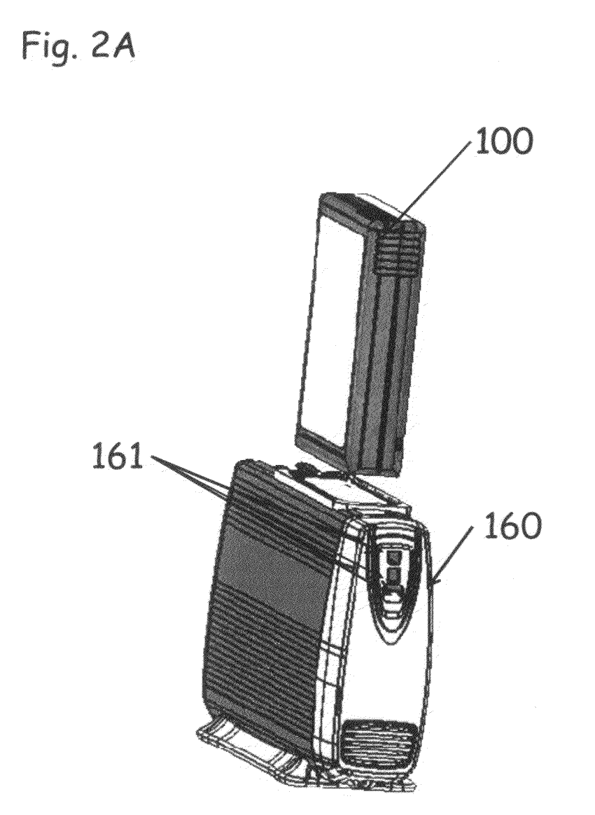

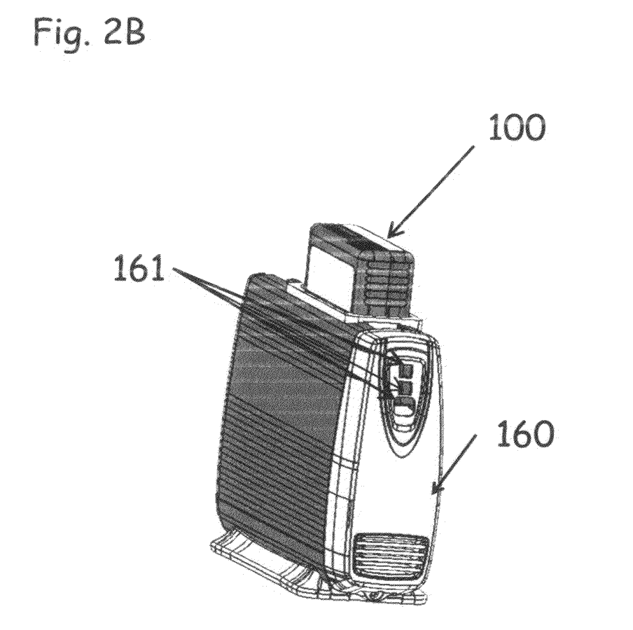

FIG. 2A shows the desktop external drive 160 with the hard drive cartridge 100 poised and oriented to fit into the desktop external drive 160. User feedback and input controls (power and disc access light, backup button, sensor for infix remote or other feedback and input controls) 161 are situated facing the user on the narrow side of the enclosure, placing the bulk of the unit facing away from the user. This orientation optimizes useable desk space by placing the bulk of the unit on the ‘deal space’ further away from the user. FIG. 20 shows the desktop external drive 160 with the hard drive cartridge 100 inserted into the desktop external drive 160 such that it is operational.

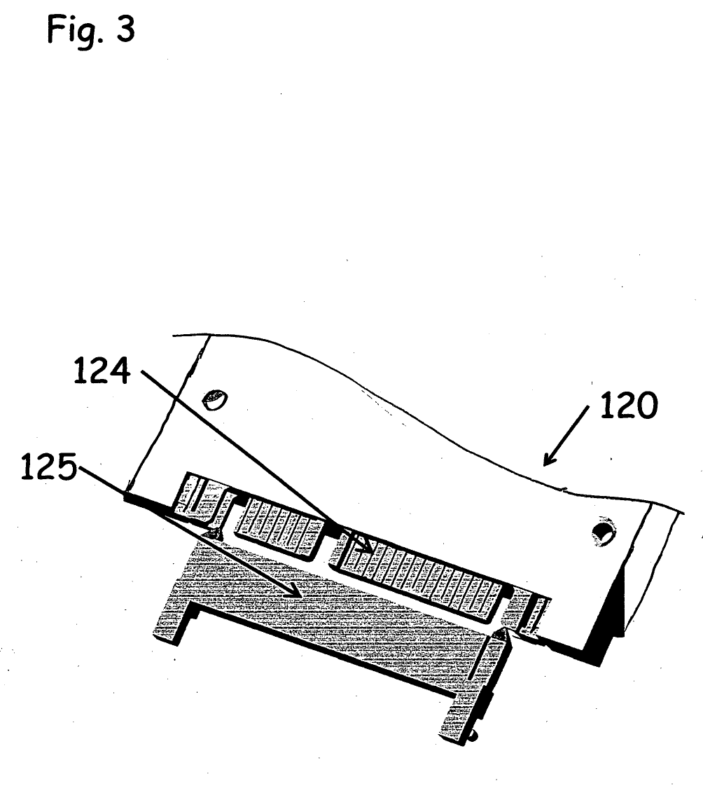

FIG. 3 shows a close up view of the electrical connector 125 on the hard drive 120 inside the hard drive ridge 100 about to be inserted into the receiving connector 126 on the desktop external drive 160. The illustrated connector uses the SATA interconnection specification. It can be seen that insertion will generate a resisting force. The SATA specification allows this insertion fore to be as high as 45 Newtons. By orienting the insertion direction in the vertical direction, the desk provides resistance to the insertion force. This is an improvement on prior at where the insertion force acts in the horizontal plane, tending to push the desktop external drive across the desk. Similarly, the removal force is required by the SATA specification to be a minimum of 10 Newtons. By orienting the cartridge removal in the vertical plane, the weight of the desktop external drive works to resist being lifted up by the removal force or being pulled across the desk in the case of horizontal removal direction as is done by prior art

While the present invention has been particularly shown and described with reference to the prefer mode as illustrated in the drawing, it will be understood by one skilled in the art that various changes in detal may be effected therein without departing from the spirit and scope of the invention as defined by the claims.

We claim:

1. A desktop external computer peripheral device that accepts a removable hard drive cartridge that inserts the hard drive cartridges in the vertical orientation and is configured to present the narrow edge of the hard drive cartridge towards the user.
